(19) United States
(12) Patent Application Publication
(10) Pub. No.: US 2026/0332640 A1
(43) Pub. Date: Oct. 22, 2026

(54) SYSTEMS AND METHODS FOR LOCAL DETECTION OF UNSECURED NETWORK RESOURCES

(71) Applicant: Obsidian Security, Inc., Palo Alto, CA (US)

(72) Inventors: Marcus McCurdy, Haddon Township, NJ (US); Craig Slusher, Havertown, PA (US); Steven Berlan, Sound Beach, NY (US)

(73) Assignee: Obsidian Security, Inc., Palo Alto, CA (US)

(21) Appl. No.: 19/180,696

(22) Filed: Apr. 16, 2025

(51) Int. Cl. H04L 9/40; G06F 16/583

(52) U.S. Cl. CPC H04L 63/1483; G06F 16/583

(57) ABSTRACT

At least one aspect of the technical solutions described herein relate to a system. The system can include one or more processors coupled with memory. The system can capture a screenshot of a web page accessed via a browser application. The system can generate an image embedding for the screenshot using an embeddings model. The system can generate a similarity score between the image embedding and a reference embedding corresponding to a reference domain. The system can interrupt access to the web page based on the similarity score satisfying a threshold and a domain of the web page not matching the reference domain.

### TECHNICAL FIELD

This application relates generally to systems and methods to perform phishing detection via a browser extension.

### BACKGROUND

Web-based access to network resources can be mediated using authentication portals, which can take the form of login pages. Login pages can include interfaces via which a user can input authentication credentials (e.g., username, password, other identifiers, etc.) to request access to protected network resources, such as network domains or applications. Attackers use phishing web pages, which purport to be legitimate login pages, to attempt to gain unauthorized access to protected network resources.

### SUMMARY

Various approaches attempt to detect instances of phishing pages that appear to be legitimate login pages. Such traditional approaches to phishing detection use rule-based techniques to identify illegitimate login pages. However, such approaches fall short due to their inability to address sophisticated phishing techniques, such as phishing pages that obfuscate webpage content through the use of dynamic JavaScript execution, inline frames, or encrypted payloads, among other concealment techniques. Such conventional approaches generally fail to adapt to evolving attack vectors that evade static detection criteria, leading to inconsistent threat identification. Additionally, traditional rule-based techniques are prone to generating false positives or false negatives due to reliance on fixed patterns that do not account for normal variations in legitimate web traffic.

To address such shortcomings, the technical solutions described herein implement a browser extension that automatically uses visual information of a webpage to determine whether the webpage corresponds to a phishing attempt. To do so, the systems and methods described herein can capture and process a screenshot of the webpage to create an embedding using a machine learning model. The embedding can be compared to a database of reference embeddings generated from images of legitimate login pages. The systems and methods described herein can generate a similarity score between the embedding generated from the screenshot of the webpage and the reference embeddings derived from legitimate login pages of trusted domains. If the comparison results in a similarity score that satisfies a threshold, and if the uniform resource locator (URL) or uniform resource identifier (URI) of the webpage does not match that of a trusted domain, the systems and methods described herein can determine that the webpage corresponds to a phishing attempt and interrupt access accordingly. In this manner, the systems and methods described herein can protect sensitive authentication information while minimizing on the computational cost of detecting phishing attempts.

At least one aspect of the technical solutions described herein relate to a system. The system can include one or more processors coupled with memory. The system can capture a screenshot of a web page accessed via a browser application. The system can generate an image embedding for the screenshot using an embeddings model. The system can generate a similarity score between the image embedding and a reference embedding corresponding to a reference domain. The system can interrupt access to the web page based on the similarity score satisfying a threshold and a domain of the web page not matching the reference domain.

In some implementations, the system can block network access to the web page based on the similarity score satisfying the threshold and the web page not corresponding to the domain. In some implementations, the system can capture the screenshot of the web page using a browser extension of the browser application. In some implementations, the system can generate a plurality of similarity scores by comparing the image embedding to a plurality of reference embeddings, wherein the reference embedding is a first reference embedding of the plurality of reference embeddings. In some implementations, the system can receive the plurality of reference embeddings from a computing system.

In some implementations, the embeddings model can include one or more pre-trained convolution layers and at least one fine-tuned fully connected layer. In some implementations, the system can generate a notification indicating that the web page corresponds to a phishing attempt. In some implementations, the system can determine that access to the web page is to be restricted further based on at least one element of the web page. In some implementations, the similarity score can be one of a cosine similarity, and L1 similarity, or an L2 similarity. In some implementations, the system can store the reference embedding in a local database.

In some implementations, the system can capture the screenshot of the web page upon navigation to the web page. In some implementations, the system can capture the screenshot of the web page based on a delay period following navigation to the web page. In some implementations, the system can train the embeddings model using a training dataset comprising a plurality of images depicting a respective plurality of login pages. At least two of the plurality of images include different dimensions. In some implementations, the system can interrupt access to the web page by preventing one or more interactions with the web page. In some implementations, the system can identify a uniform resource locator (URL) or uniform resource identifier (URI) associated with the web page. In some implementations, the system can determine the domain of the web page based on the URL or the URI.

At least one aspect of the technical solutions described herein relate to a method. The method can be performed, for example, by one or more processors coupled to memory. The method can include capturing a screenshot of a web page accessed via a browser application. The method can include generating an image embedding for the screenshot using an embeddings model. The method can include generating a similarity score between the image embedding and a reference embedding corresponding to a reference domain. The method can include interrupting access to the web page based on the similarity score satisfying a threshold and a domain of the web page not matching the reference domain.

In some implementations, the method can include blocking network access to the web page based on the similarity score satisfying the threshold and the web page not corresponding to the domain. In some implementations, the method can include capturing the screenshot of the web page using a browser extension of the browser application. In some implementations, the method can include generating a plurality of similarity scores by comparing the image embedding to a plurality of reference embeddings, wherein the reference embedding is a first reference embedding of the plurality of reference embeddings.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification. Aspects can be combined, and it will be readily appreciated that features described in the context of one aspect of the invention can be combined with other aspects. Aspects can be implemented in any convenient form, for example, by appropriate computer programs, which may be carried on appropriate carrier media (computer readable media), which may be tangible carrier media (e.g., disks) or intangible carrier media (e.g., communications signals). Aspects may also be implemented using any suitable apparatus, which may take the form of programmable computers running computer programs arranged to implement the aspect. As used in the specification and in the claims, the singular form of ‘a,’ ‘an,’ and ‘the’ include plural referents unless the context clearly dictates otherwise.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 illustrates a block diagram of a system for managing network identifiers in distributed computing systems, according to an embodiment;

FIG. 2 illustrates an example of a process of providing a network identifier to a computing device, according to an embodiment;

FIG. 3 illustrates a sample user interface that includes a website with a generated phishing attempt, according to an embodiment;

FIG. 4 illustrates an example of a process of training a machine learning (ML) model to generate image embeddings, according to an embodiment;

FIG. 5 illustrates a flow diagram of a method for managing network identifiers in distributed computing systems, according to an embodiment; and

FIG. 6 illustrates a sample computing system, according to an embodiment.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting of the subject matter presented.

Some implementations are related to a browser extension for a web browser. In some implementations, the browser extension can be a plugin that is installed in an environment of and/or configured to interact with the web browser. The browser extension can be associated with an identifier that is unique to that (1) user and/or user's compute device and (2) browser. Said differently, each browser used by each user and/or user computing device having the browser extension can be associated with an identifier that is different from other browsers, browser extensions, users and/or user computing devices.

When analyzing the visual content, the browser extension can capture a screenshot or an image on the sites visited in the browser while capturing the encrypted and decrypted data. By utilizing the screenshots, the browser extension can generate embeddings using a machine learning model (e.g., embeddings model) to perform the phishing detection. In some implementations, a “suspected phishing site” refers to a site predicted to be a phishing site without certain proof, whether or not the suspected phishing site is actually a phishing site. In some implementations, a “phishing site” refers to an actual phishing site. Additionally or alternatively, in some implementations, the browser extension can be used to perform attestation. Attestation can provide assurance that the properties of a device (e.g., the serial number) and/or activities performed by the device are legitimate and not spoofed.

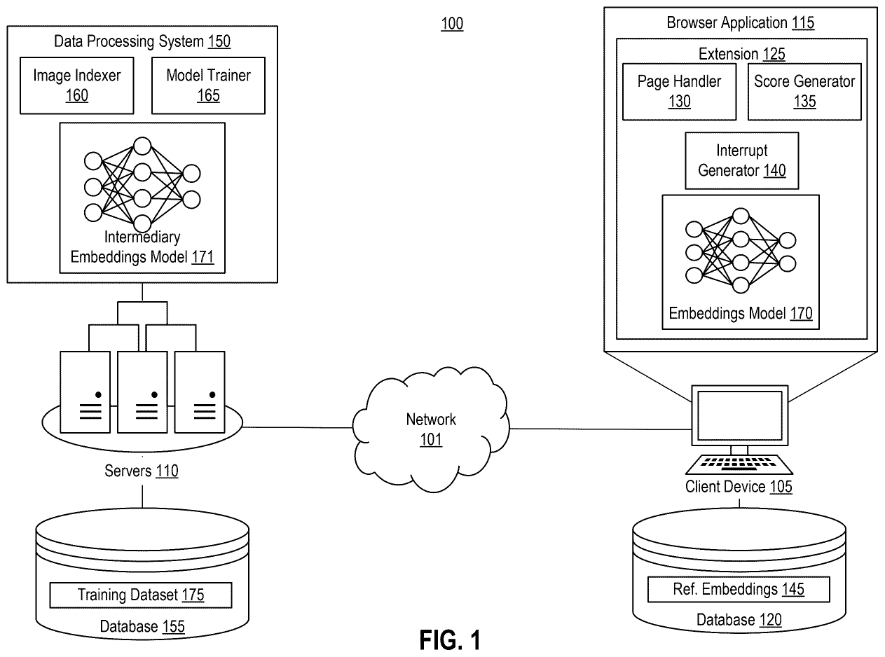

FIG. 1 illustrates a block diagram of a system 100 for managing network identifiers in distributed computing systems. The system 100 can include at least one client device 105 and one or more servers 110. The client device 105 executing a browser application 115 (referred to as browser 115 herein) can render a user interface (UI) and can store or otherwise maintain a database 120. The browser application 115 can include a website that includes, stores, or otherwise maintains a browser extension 125 (sometimes referred to as “extension 125”). The extension 125 can include at least one page handler 130, at least one score generator 135, at least one interrupt generator 140, and at least one embeddings model 170. The database 120 (e.g., local database) can include a plurality of reference embeddings 145. The servers 110 can house or execute a data processing system 150 that is coupled to a database 155 (e.g., remote database). The data processing system can include at least one image indexer 160, at least one model trainer 165, and at least one intermediary embeddings model 171. The database 155 can include a training dataset 175. The servers and the at least one computing device can be communicatively coupled via at least one network 101.

The browser 115 can be a software program that runs within a web browser. The software program can include one or more instructions embedded within code in a functional language (e.g., Python, Java, etc.) to allow a user of a client device 105 to interact with content and other services accessible by the web (e.g., internet). The browser 115 can include Hyper Text Mark-Up Language (HTML), cascading style sheet (CSS), JavaScript, among others to define a user interface of the client device 105. The browser 115 can be in communication with or can include servers 110, databases (e.g., database 155, database 120), application programming interfaces (APIs), among others to process requests and store data.

The extension 125 can be any type of browser extension and/or plugin that can trigger or cause the client device 105 to perform and/or execute any of the tasks/processes described herein. The extension 125 can be included with the browser 115, and can monitor content of any webpage, web site, or web domain of the client device 105. The extension 125 can include instructions to capture images of the webpage, provide reference embeddings, and in some implementations, transmit data to the server 110, as described in further detail herein. The extension 125 can be installed on the browser 115 at the client device 105. The extension 125 can be associated with an identifier that is unique to browser and at least one of the browser 115 or client device 105. The identifier may be generated and/or assigned (e.g., by the computing device) when and/or after browser extension 125 has been installed for the browser 115.

The extension 125 can execute a page handler 130. The page handler 130 can include hardware, software, or any combination thereof to perform various operations described herein. The extension 125 can execute a score generator 135. The score generator 135 can include hardware, software, or any combination thereof to perform various operations described herein. The score generator 135 can generate, determine, otherwise identify a score for each embedding representing a screenshot of a login page, as described herein. The extension 125 can execute an interrupt generator 140. The interrupt generator 140 can include hardware, software, or any combination thereof to perform various operations described herein. The interrupt generator 140 can generate, determine, or otherwise identify an interrupt for the client device 105. The extension 125 can execute an embeddings model 170.

In further detail, the data processing system 150 can be any computing device including one or more processors coupled with memory. The data processing system 150 can include hardware, software, or combinations thereof that can perform any of the various processes/tasks described herein. In some implementations, the data processing system 150 can be, or may be part of, a computing system (e.g., a server, an end-user computing device such as a laptop, PC, smart device, etc.) or within a server group (e.g., a data center, a branch office, or a server site), and include instructions to train the embeddings model 170 (e.g., intermediary embeddings model 171), update, and/or generate reference embeddings, and/or store or update the training dataset. The data processing system 150 can be in communication with the client device 105. In some implementations, the image indexer 160 can manage, receive, or otherwise obtain a plurality of images from various sources, including image datasets, external computing systems, login pages of trusted domains (e.g., where the image indexer 160 captures images thereof, etc.), or one or more client devices 105, among others, for training the intermediary embedding model 171. The model trainer 165 can train, establish, or otherwise initialize the ML model 170. The intermediary embeddings model 170 (e.g., ML model 170) can be trained to generate, identify, or otherwise determine a plurality of embeddings for images.

In further detail, the embeddings model 170 and the intermediary embeddings model 171 can be any type of ML model to determine embeddings based on images. The embeddings model 170 can be maintained as part of, or in association with, the extension 125. The intermediary embeddings model 171 can be maintained as part of or in association with the data processing system 150. Each of the embeddings model 170 and the intermediary embeddings model 171 can include, for example, a convolutional neural network (CNN) that includes pre-trained convolutional layers, fine-tuned fully connected output layers, pooling layers, dropout layers, flattening layers, activation functions, among others. Other examples of the embeddings model can include a deep learning artificial neural network (ANN) such as an encoder-decoder model with a convolution neural network architecture, a transformer architecture, a diffusion model, a diff hash perceptual image hashing algorithm, or an encoder-classifier model, among others. The intermediary embeddings model 171 can be initialized, trained, and established using training data in accordance with learning techniques (e.g., supervised or semi-supervised). Once initialized, the data processing system 150 can provide the intermediary embeddings model 171 to the extension 125 as the embeddings model 170.

The database 120 and the database 155 can be structured or unstructured repository to store, manage, and retrieve data associated with the system 100 or the client devices 105, and the data processing system 150. The database 120 can be stored locally within the client device 105 or remotely. In some implementations, the database 155 can be managed by a Database management system (DMBS) and can be at least one of a MySQL, PostgreSQL, NoSQL, among other databases. The database 155 can include at least one training dataset 175 to train the embedding model 170. The database 120 can include reference embeddings 145 for comparison by the extension 125 as described in further detail herein.

The system 100 is not confined to the components described herein and may include additional or alternate components, not shown for brevity, which are to be considered within the scope of the embodiments described herein.

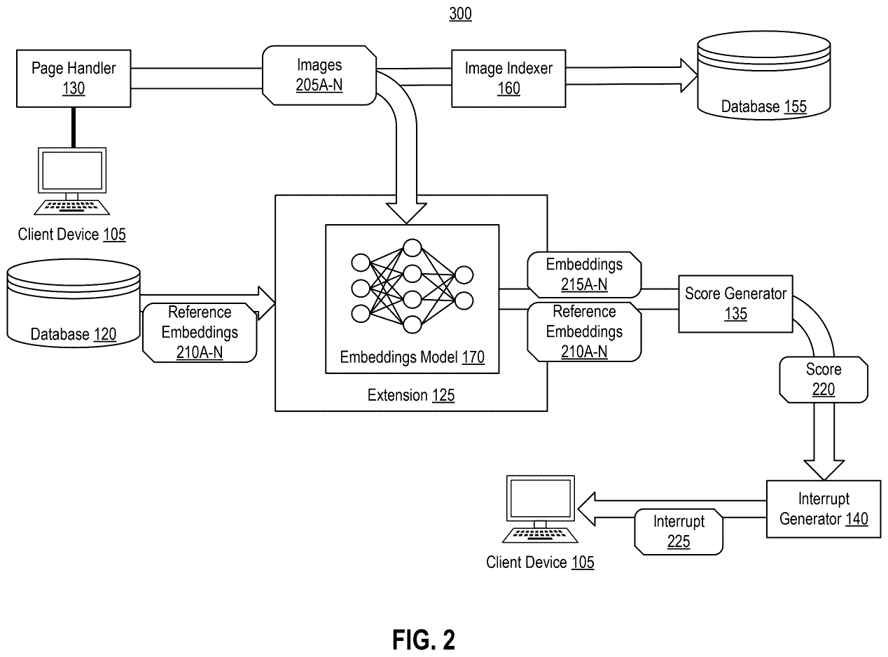

FIG. 2 illustrates an example of a process 200 of detecting phishing attempts using the techniques described herein. The process 200 can include or correspond to operations performed in the system 100. Under the process 200, the page handler 130 can capture, obtain, or otherwise generate a screenshot of a webpage. The page handler 130 can identify, determine or otherwise indicate a uniform resource locator (URL) or uniform resource identifier (URI) associated with the web page. The page handler can use the URL or the URI to determine a domain of the webpage. The page handler 130 can trigger or cause the client device 105 to capture the screenshot using the extension 125 of the webpage or browser application. For instance, the page handler 130 can cause the client device 105 to maintain a screen buffer to hold a display of the browser. Based on the screen buffer, the page handler 130 can process the screen buffer convert the browser into an image 205. The page handler 130 can capture a plurality of screenshots of a web page rendered by the browser as a plurality of images 205. In some implementations, the page handler 130 can convert the screenshots into a plurality of images 205 (e.g., converting raw pixel data to a specific image format).

In some instances, the page handler 130 can capture the screenshots based on a navigation or interaction with the webpage. The navigation or the interaction can include a mouse event, keyboard event, touch event, scroll event, resize event, a rotation event, audio input detection, or a voice input detection, among other interactions. The page handler 130 can detect the navigation or interaction within the webpage using one or more event listeners or sensors configured by the extension 125 or embedded within the webpage. The interactions can be initiated by a user input device, such as, a mouse, a keyboard, a smart phone, among others to initiate an interaction with the webpage. For example, the page handler 130 can detect a mouse click on at least one portion of the webpage at an instance of time. Concurrently to detecting the mouse click, the extension 125 can trigger the page handler 130 to capture a screenshot of the webpage indicating the portion in which the mouse click was detected. In another example, the page handler 130 can detect a resize of the webpage from a first size to a second size. The page handler 130 can capture a screenshot of the webpage at the second size.

In some instances, the page handler 130 can capture the screenshots based on a delay period in response to the navigation or the interaction with the webpage. The delay period can correspond to predetermined period of time, intervals of time, dynamically determined period of time, among other periods of time. For example, a webpage can take a time to render its contents. The page handler 130 can adjust the delay period to prevent the capture of the screenshots while the contents load and render on the webpage. In another example, the page handler 130 can capture a screenshot of the webpage upon an expectation of the predetermined delay period. In some instances, the page handler 130 can configure the delay period based on one or more factors in respond to detecting the interaction with the webpage. The factors can include a signal strength, a network connection, computer utilization, memory, available computing resources, among other factors associated with the client device 105. For example, the page handler 130 can increase the delay period in response to a poor network connection at the client device 105. Upon expiration of the increased delay period, the page handler 130 can capture the screenshot of the webpage. In some instances, the page handler 130 can capture multiple screenshots following the expiration of the delay period.

The plurality of images 205 can be captured from the page handler 130 executing on the client device. In some implementations, the images 205 can be generated and/or converted to have a format including at least one of a JPEG, a PNG, a JPG, a PDF, among other formats for the images 205. In some implementations, the images 205 can be arrays and/or data structures storing pixel information for one or more pixels of the screenshot(s) captured via the page handler 130. Each image 205 can include a different dimension from a subsequent image 205. Each image 205 can be of a browser that is a “phishing website.” The phishing websites can mimic, copy, or otherwise be relatively indistinguishable from a non-phishing web page. Since the phishing website can copy a non-phishing website, such phishing sites often capture sensitive information leading to privacy concerns and data exposure. The systems and methods described herein address these issues by using an embeddings model to generate embeddings for the images 205.

In some implementations, the page handler 130 can transmit, provide, or otherwise send the images 205 to the image indexer 160 of the data processing system 150 for storage in the database 155. The page handler 130 can generate a request prior to the transmission of the images 205. The request can include identification information of the respective client device 105 providing the images. For example, the request can include an IP address of the client device 105, a media access control (MAC) address of the client device 105, the browser of the image 205, a number of images 205, among other factors associated with the client device 105. In this manner, the request can allow for the client device 105 to initiate the detection of the phishing webpage in real time (or near real time) without latency issues suffered by conventional solutions. In some instances, the page handler 130 can transmit the request to the image indexer 160 in the event that one or more networks (e.g., network 101) is down or the data processing system 150 is otherwise inaccessible. For example, the client device 105 can be connected an access point via a local area network (LAN), thereby allowing the page handler 130 to connect with the data processing system 150. The page handler 130 can transmit the images to the data processing system 150 upon acceptance of the request by the image indexer 160.

The page handler 130 can provide an image 205 as input to the embeddings model 170 to generate an embedding representing the image 205. In some implementations, the page handler 130 can pre-process images 205 prior to providing the images as input to the embeddings model 170. For example, in some implementations, the page handler 130 can resize the images 205 to a predetermined resolution for feeding to the embeddings model 170. By resizing the images 205, the page handler 130 can provide a uniform input size for the CNN. In some implementations, the page handler 130 can normalize each pixel within the images 205. In normalization, each pixel can be scaled to optimize and improve convergence during training (e.g., scaled between 0 and 1, include zero mean and unit variance). In some implementations, the page handler 130 can adjust the color of each pixel (e.g., greyscale, RGB). The page handler 130 can apply one or more filters to remove noise from the images 205 to allow an easier extraction of features.

The extension 125 can apply, execute, or otherwise provide captured image(s) 205 as input to the embeddings model 170. The embeddings model 170 can include at least one fully connected layer and one or more pretrained convolutional layers. The plurality of fully connected layers (sometimes referred to as dense layers) can include plurality of neurons, each with at least one weight value and in some implementations a bias value. The weight values of a dense layer can be represented using a weight matrix and the bias values of the dense layer can be represented using a bias vector, in some implementations. Each neuron in a dense layer can receive each output of the immediate previous layer in the embeddings model 170. The neurons can correspond to features or patterns extracted by one or more convolution layers of the embeddings model 170. By forming the patterns, the fully connected layers can classify and predict the embeddings 215.

The weight matrix can include weights for each connection (e.g., edges) between the neurons. The weight matrix can include dimensions n x m. n can represent the number of neurons in a previous layer and m can represent the number of neurons in the current layer. The weights can be initialized with random values to allow the embedding model to learn features associated with the images 205. The weight matrix can be used to execute linear transformation on the input vector (e.g., images 205).

The bias vector can include biases that are added to the linear transformation of the as described in the weight matrix. In some instances, the size of the bias matrix can correspond or refer to the number of neurons within a respective layer. The extension 125 can use the embeddings model 170 to generate, determine, or otherwise identify at least one embedding 215 based on using the captured image(s) 205 of web pages accessed via the browser application 115. In some implementations, the embeddings model 170 can execute dimensionality reduction, feature extraction, or sequence modeling to generate the embeddings 215. The fully connected layers of the embeddings model 170 can generate the embeddings 215 by processing the various features generated from activation maps of the convolutional layers. In some implementations, the fully connected layers can execute or perform one or more transformations of the embeddings 215 and applying activation functions to generate output embeddings 215. In some implementations, the fully connected layers can include one or more hidden layers. The embeddings 215 generated by the embeddings model 170 can be stored in a vector format, in some implementations. For example, the embeddings 215 can be a vector of floating-point numbers that represent output the semantic/visual features (e.g., text, images, and other types of content) of the input images 205. The structure of the embeddings 215 can be similar to the reference embeddings 210, as described herein.

The score generator 135 of the extension 125 can generate, identify, or otherwise determine a similarity score 220 (referred to as a score 220) between the generated embeddings 215 and the reference embeddings 210. To do so, the score generator 135 can perform a comparison operation (e.g., a vector comparison operation) over the database 120 storing the reference embeddings 210 using the embeddings 215 generated by the embedding model 170. The scores 220 can numerically represent the similarity between the embeddings 215 and each of the reference embeddings 210 and. In some implementations, the score generator 135 can generate the score 220 as cosine similarity and L1 similarity or L2 similarity to determine or identify a delta for how similar the reference embeddings 210 are to the embeddings 215. Calculating the cosine similarity can include calculating a dot product of the vectors and dividing the result by a product of the magnitudes of each vector. In some implementations, the output of the cosine similarity can range from 0 to 1. Output values closer to 1 can indicate a high similarity between the vectors. Output values closer to 0 can indicate no similarity. In some instances, the output of the cosine similarity can range from −1 to 1. Output values closer to −1 can indicate that the vectors are diametrically opposed. The output of the cosine similarity can be provided as the similarity score 220.

The score generator 135 can use the scores 220 to generate, identify, or otherwise determine an indication of whether the domain of the webpage matches a reference domain of a corresponding reference embedding 215. Identifiers of reference domains can be stored in the database 120 in association with corresponding reference embeddings 210. The reference domains can correspond to legitimate, non-phishing websites. If the domain of the webpage being accessed by the browser application does not match the reference domain but has visual elements that strongly resemble a legitimate login page (e.g., as indicated by the score 220 being greater than a threshold, such as 0.5, 0.75, etc.), the score generator 135 can determine that the domain of the webpage corresponds to a phishing attempt. The score generator 135 can provide the score 220 to the interrupt generator 140.

The interrupt generator 140 can generate, determine, or otherwise provide an interrupt 225 for the client device 105. The interrupt 225 can be a marker, a flag, a code, instructions, or a system call to interrupt or prevent access to the webpage. The interrupt generator 140 can generate the interrupt 225 based on the score 220 satisfying a threshold and the domain of the webpage not matching the reference domain. In some implementations, the interrupt generator 140 can generate the interrupt 225 based on the score satisfying the threshold. The threshold can be indicative of a sufficient similarity between the reference embeddings 210 and the embeddings 215 of the web page. For example, a score 220 that is closer to 1 in the range of 0-1 that satisfies a threshold and includes a domain of the browser that does not match the reference domain can cause the interrupt generator 140 to generate the interrupt 225. In some implementations, the interrupt generator 140 can generate instructions for the interrupt 225 that cause access to the webpage to be restricted based on at least one element (e.g., actionable object, graphical user interface element) on the web page. For example, in some implementations, particular interactive elements (e.g., password fields, username fields, other elements that can receive authentication credentials, etc.) may be restricted from interaction by generating code and/or modifying the DOM of the webpage to prevent interaction with those elements. In some implementations, the interrupt 225 can prevent the interactions by using at least one of HTML attributes or CSS overlays, among others to restrict access to the data fields of a login page.

The interrupt generator 140 can provide or output, the interrupt 225 at the client device 105. Upon reception or detection of the interrupt 225 (e.g., detection of an interrupt event or message from the extension 125), the client device 105 can interrupt or block access to the webpage in real time (or in near real time) to prevent further interactions (e.g., one or more interactions) with the webpage or to warn the end-user of a potential phishing attempt.

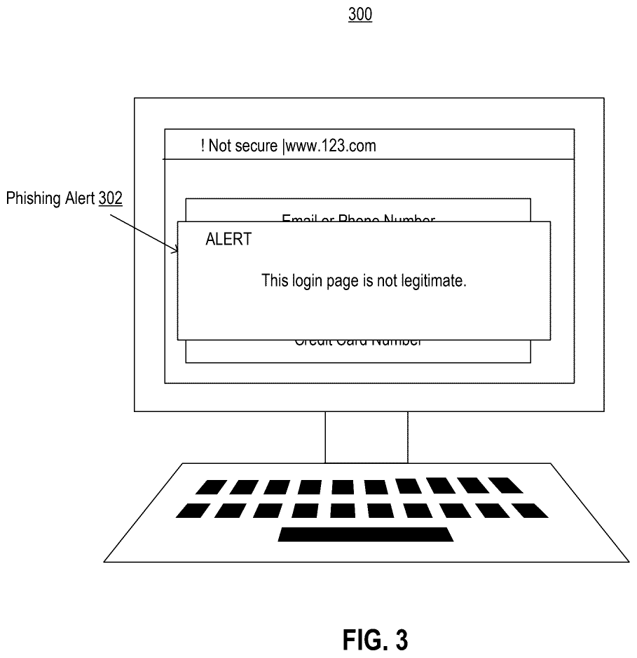

The interrupt 225 can include an alert or pop-up that indicates the currently displayed webpage is likely a phishing attempt. FIG. 3 illustrates an example user interface 300 that includes a webpage with a phishing alert 302. As shown in the sample user interface 300, the phishing alert 302 can appear in a portion of the web page to warn the user of the client device 105 of the security risk of inputting information into the webpage. In some implementations, the interrupt 225 can restrict interactions associated with the web page. The interrupt generator 140 can generate, identify, or otherwise provide a notification that indicates that the webpage corresponds to the phishing attempt. The notification can be an email, an icon in the extension 125, a text message, a warning sound, among other notifications. In some implementations, the interrupt generator 140 can store one or more indications of the suspected phishing attempt in one or more security logs, and/or transmit an indication of the attempted phishing attempt to the data processing system 150.

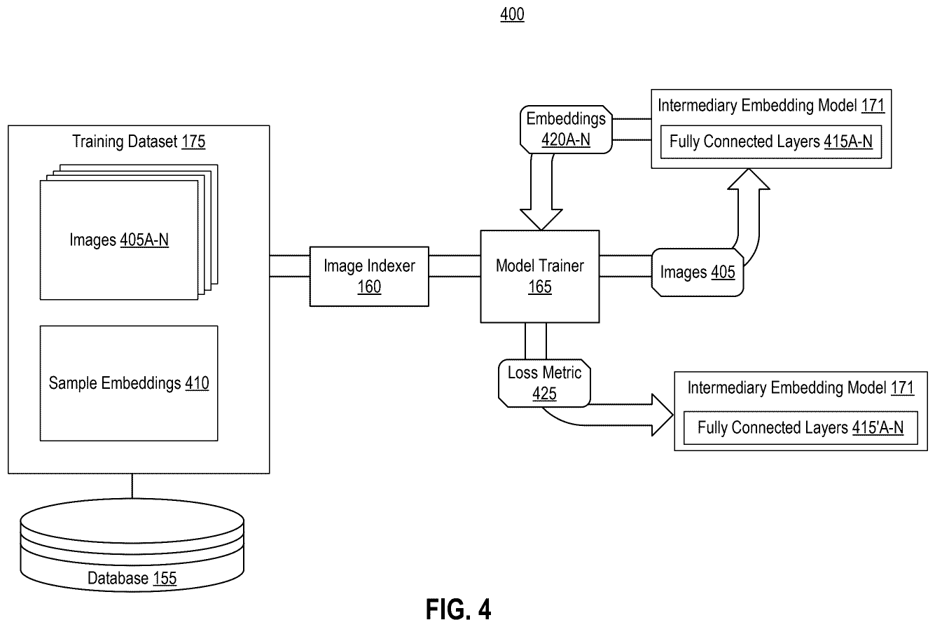

FIG. 4 illustrates an example of a process 400 of training a machine learning (ML) model 170 to generate image embeddings. The process 400 can include or correspond to operations performed in the system 100. Under the process 400, the image indexer 160 can receive, retrieve, or otherwise extract a training dataset 175 from the database 155. The training dataset 175 can include a plurality of examples. Each example of the training dataset 175 can include sample images 405A-N (sometimes referred to as images 405) and sample embeddings 410.

The training dataset 175 can includes images 405 derived from browsers of the client device 105. The images 405 can depict images of legitimate login pages captured, for example, from one or more client devices 105 or other computing devices accessing legitimate reference domains. The images 405 can be stored within the database 155. In some implementations, the images 405 can be captured using the image indexer 160, extensions 125 of one or more client devices 105, third party application, capture cards, or other automated screen tools. The images 405 can depict login pages from a variety of legitimate and/or illegitimate (e.g., phishing) domains.

The image indexer 160 can update, change, or otherwise modify the images 405 of the training dataset 175 by adding and removing the images 405 at varying time periods, such that the images 405 accurately represent up-to-date legitimate login pages. The various time periods can correspond to a predetermined schedule (e.g., hourly, daily, weekly, bi-weekly, monthly) or a dynamically updated schedule. In some implementations, the image indexer 160 can add images 405 to the training dataset 175 based on the predetermined schedule. For example, the image indexer 160 can add images 405 to the training dataset 175 bi-weekly (e.g., predetermined schedule). In some implementations, using the same schedule, the image indexer 160 can remove images 405 that are stored within the database 120 beyond a time threshold. In another example, the image indexer can add images 405 to the training dataset 175 based on a high frequency of access to the login pages from the domains. In a similar manner, the image indexer 160 can remove images from the training dataset 175 that include a low frequency of access to the login pages.

In some implementations, the image indexer 160 may receive one or more images 405 from one or more external computing systems, data sources, or databases. In some implementations, the image indexer 160 may automatically navigate to and capture screenshots of login pages of various trusted domains, using techniques similar to those described herein. Upon receipt/capture of the images 405, the image indexer 160 can store, save, or otherwise maintain the images 405 within the training dataset 175. The image indexer 160 can store the images 405 in association with corresponding metadata information (e.g., screenshot dimensions, timing information, etc.) associated with the corresponding webpages. In some implementations, the image indexer 160 can store the images in the training dataset 175 according to the URL, URI, and/or trusted domain associated with each webpage.

The sample embeddings 410 can correspond to the images 405 provided to the intermediary embeddings model 171. The sample embeddings 410 can be compared to embeddings generated by the intermediary embeddings model 171. The sample embeddings 410 can be represented as a vector similar to the reference embeddings 210 described above. The sample embeddings 410 can be generated, annotated, or otherwise determined based on each of the images 405 in the training data set 170. The sample embeddings 410 can be a ground truth for the intermediary embedding model 171 based on the reference embeddings 210 as described herein. The image indexer 160 can populate or generate the sample embeddings 410 using each of the reference embeddings 210. In some implementations, the image indexer 160 can use the reference embeddings 210 to establish the sample embeddings 410 within the training dataset 175. The reference embeddings 210 can include embeddings derived from images of web pages (e.g., login pages) of legitimate domains. In some implementations, the sample embeddings 410 can include embeddings represented web pages from known illegitimate web pages (e.g., known phishing webpages).

Each of the sample embeddings 410 (e.g., reference embeddings 145) can correspond to screenshots or images captured from various webpages. In some implementations, to generate the training dataset 175, the image indexer 160 can access a plurality of domains, webpages, or browsers to capture various screenshots of non-phishing and phishing webpages (e.g., legitimate and non-legitimate). Each of the images 405 can be stored within the database 155 and/or within the training dataset 175. The image indexer 160 can update the images 405 according to a schedule, in some implementations. The schedule can define one or more time periods that updates to the images 405 can occur. In this manner, the image indexer 160 can update the images 405 and the sample embeddings 410 to establish the training dataset 175.

In an example training process for the intermediary embeddings model 171, the model trainer 165 can extract, obtain or otherwise access the images 405 from the training dataset 175. The model trainer 165 can apply, feed, or otherwise input the images 405 from the training dataset 175 to the intermediary embeddings model 171. The intermediary embeddings model 171 can include at least one fully connected layer 415 (sometimes referred to as a plurality of fully connected layers 415, dense layers 415, or fully connected layers 415 herein) that is to be trained/fine-tuned and one or more pre-trained convolutional layers that can be frozen (e.g., held constant and not updated) during training/fine-tuning. The pretrained convolutional layers can extract features from the images 405 for that are provided to the fully connected layers 416 to generate output embeddings 420. In some implementations, the convolutional layers can be pretrained layers that were updated using an external training dataset.

As described herein, the dense layers of the intermediary embeddings model 171 can include plurality of neurons, which may be represented using one or more of a weight matrix and a bias vector. The neurons can receive the data indicating features or patterns extracted by one or more convolution layers of the intermediary embeddings model 171. By forming the patterns, the fully connected layers can classify and predict the embeddings 215.

The weight matrix can include weights for each connection (e.g., edges) between the neurons. The weight matrix can include dimensions n x m. n can represent the number of neurons in a previous layer and m can represent the number of neurons in the current layer. At the first iteration of training, the weights of the fully connected layers 415 can be initialized with random values to allow the embedding model to learn features associated with the images 205. The weight matrix can be used to execute linear transformation on the output of the convolutional layers.

The bias vector can include biases that are added to the linear transformation of the as described in the weight matrix. In some instances, the size of the bias matrix can correspond or refer to the number of neurons within a respective layer. In some instances, the intermediary embeddings model 171 can be updated according to a plurality of parameters. In some embodiments, the plurality of parameters can include a plurality of hyperparameters for training/fine-tuning the intermediary embeddings model 171 to generate the embeddings 215, such as learning rate, batch size, or number of training epochs, among others.

In some implementations, the fully connected layers 415 can use the activation functions to generate the embeddings 420. In some implementations, the intermediary embeddings model 171 can include multiple fully connected layers 415, which can operate as one or more hidden layers that transform the features of the images 405 extracted by the convolutional layers. The embeddings 420 generated at the output layer of the intermediary embeddings model 171 can be a numerical representation of the images 405 extracted from the training dataset 175 provided as input to the intermediary embeddings model 171 to capture or indicate features of login pages (e.g., legitimate login pages, phishing web pages, etc.). The embeddings 420 can be a vector that are represented by floating-point numbers to represent output data (e.g., text, images, and other types of content).

The model trainer 165 can obtain the embeddings 420 from the intermediary embeddings model 171. To update the intermediary embeddings model 171, the model trainer 165 can update, modify, or otherwise change the trainable parameters of the fully connected layers 415 of the intermediary embeddings model 171. The trainable parameters can be iteratively updated to minimize a loss function of the intermediary embeddings model 171 during training/fine-tuning. The trainable parameters can include target weights or biases (e.g., influence the output of the intermediary embeddings model 171 based on accurate embeddings 420), loss function (e.g., compound loss), among others.

In some implementations, the model trainer 165 can update or modify the intermediary embeddings model 171 as a Siamese network with triplet loss. The triplet loss can be a type of loss function that uses similarity learning. The triplet loss can execute on triplets of samples, such as an anchor, positive examples, and negative example. The anchor can be the reference sample (e.g., sample embeddings 410) indicating the legitimate login page. The positive example can be samples similar to the anchor (e.g., images 405). The negative example can be samples that are not similar to the anchor (e.g., images 405). Using the triplet loss, the model trainer 165 can generate or otherwise determine a loss metric 425 to improve the intermediary embeddings model 171.

To update the weights of the fully connected layers 415 of the intermediary embeddings model 171, the model trainer 165 can determine, calculate, or otherwise generate at least one least one loss metric 425 based on the comparison of the embeddings 420 and the sample embeddings 410 (e.g., image 405 in the same domain as the anchor). The loss metric 425 can measure, rate, or identify how well the intermediary embeddings model 171 can determine accurate embeddings 420 based on the images 405. In some embodiments, the loss metric 425 may be generated using one or more of the loss functions described herein to quantify the difference between embeddings 420 and the sample embeddings 410 within the training dataset 175 to optimize the trainable parameters of the intermediary embeddings model 171 during training. In some implementations, the loss function can be at least one of Mean Squared Error, Binary Cross-Entropy Loss, Categorical Cross-Entropy Loss, Hinge Loss, triplet loss, or Wasserstein Loss.

In some implementations, the model trainer 165 can generate the loss metric 425 according to sigmoidal loss. To generate the loss metric 425, the model trainer 165 can calculate an L1 distance between sample embeddings 410 and the embeddings 420. The sample embeddings 410 and the embeddings 420can be an authentication page and a phishing page or an authentication page and a non-phishing, respectively. The model trainer 165 can transmit or send the L1 distance through the final layer of the fully connected layer and through a logistic layer. From here, the model trainer 165 can generate the loss metric 425 using a binary cross entropy loss function based on the output through the logistic layer.

The model trainer 165 can update, further train, or otherwise fine-tune the at least one of the fully connected layers 415 in the intermediary embeddings model 171 using the loss metric 425. In some embodiments, the model trainer 165 can adjust trainable parameters (e.g., weights, biases) of the fully connected layers 415 so the intermediary embeddings model 171 can generate more accurate embeddings 420. For example, the model trainer 165 can use the loss metric 425 to compute gradients for the direction and magnitude of parameter adjustments to minimize the loss metric 425. In another instance, the model trainer 165 can optimization algorithms such as, stochastic gradient descent, RMS prop, or an Adam optimizer to update model parameters iteratively. In some implementations, the direction and step size of the parameter update according to the gradients and the optimization algorithm. The model trainer 165 train/update the intermediary embeddings model 171 until a training termination condition has been satisfied. In one example, the training termination condition can be satisfied when performance (e.g., accuracy, etc.) of the intermediary embeddings model 171 satisfies a threshold. Once trained, the model trainer 165 can provide, transmit, or otherwise send the intermediary embeddings model 171 to the extension 125. The extension 125 can use the intermediary embeddings model 171 as the embeddings model 170 in accordance with the techniques described herein.

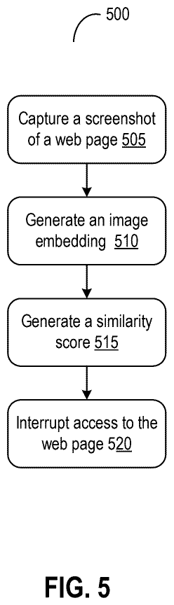

FIG. 5 illustrates a flow diagram of a method 500 for managing network identifiers in distributed computing systems, according to an embodiment. The method 500 can be implemented or performed by any components detailed herein, such as system 100 or system 600. Under the method 500, a computing system can capture a screenshot of a webpage (505). The computing system can generate an image embedding (510) using an embeddings model. The computing system can generate a similarity score between the embeddings and reference embeddings (515). The computing system can interrupt access to the webpage (520).

The computing system can capture a screenshot of a webpage (505). The computing system can capture the screenshot of the web page using a browser extension of the browser application. The computing system can capture the screenshot of the web page upon navigation to the web page. Based on the screenshots, the computing system can identify a uniform resource locator (URL) or uniform resource identifier (URI) associated with the web page and determine the domain of the web page based on the URL or the URI.

The computing system can generate an image embedding (510) using an embeddings model. The embeddings model can include one or more pre-trained convolution layers and at least one fine-tuned fully connected layer. The computing system can train the embeddings model using a training dataset comprising a plurality of images depicting a respective plurality of login pages. At least two of the plurality of images comprise different dimensions. A reference embedding can be a first reference embedding of the plurality of reference embeddings. The computing system can receive the plurality of reference embeddings from server. The computing system can store the reference embedding in a local database. The computing system can capture the screenshot of the web page based on a delay period following navigation to the web page.

The computing system can generate a similarity score between the embeddings and reference embeddings (515). The computing system can generate a plurality of similarity scores by comparing the image embedding to a plurality of reference embeddings. The similarity score can be one of a cosine similarity, and L1 similarity, or an L2 similarity.

The computing system can interrupt access to the webpage (520). The computing system can determine that access to the web page is to be restricted further based on at least one element of the web page, prior to the interrupted access. If access is to be restricted, the computing system can block network access to the web page based on the similarity score satisfying the threshold and the web page not corresponding to the domain. The computing system can interrupt access to the web page by preventing one or more interactions with the web page. The computing system can generate a notification indicating that the web page corresponds to a phishing attempt.

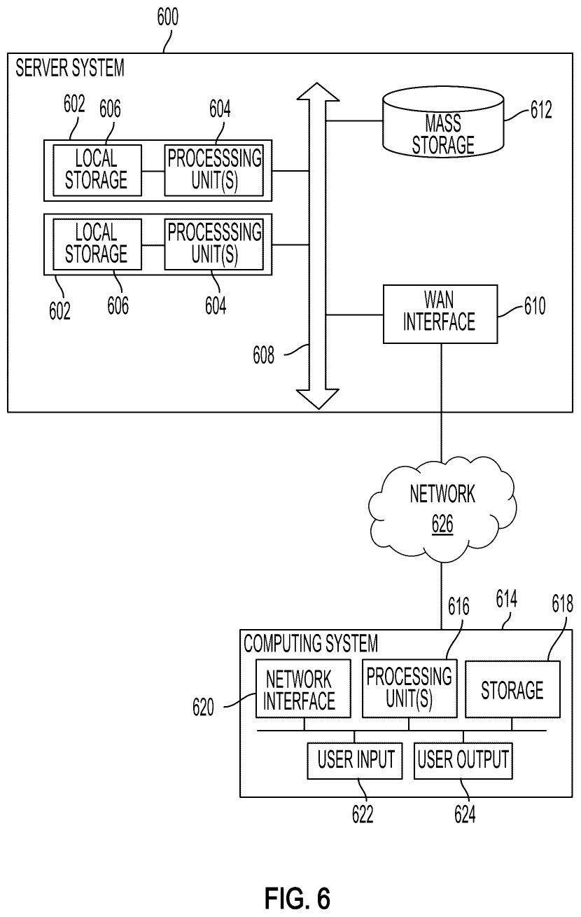

Various operations described herein can be implemented on computer systems. FIG. 6 shows a simplified block diagram of a representative server system 600, computing system 614, and network 626 usable to implement certain embodiments of the present disclosure. In various embodiments, server system 600 or similar systems can implement services or servers described herein or portions thereof. Computing system 614 or similar systems can implement clients described herein. The system 100 described herein can be similar to the server system 600. Server system 600 can have a modular design that incorporates a number of modules 602 (e.g., blades in a blade server embodiment); while two modules 602 are shown, any number can be provided. Each module 602 can include processing unit(s) 604 and local storage 606.

Processing unit(s) 604 can include a single processor, which can have one or more cores, or multiple processors. In some embodiments, processing unit(s) 604 can include a general-purpose primary processor as well as one or more special-purpose co-processors such as graphics processors, digital signal processors, or the like. In some embodiments, some, or all processing units 604 can be implemented using customized circuits, such as application specific integrated circuits (ASICs) or field programmable gate arrays (FPGAs). In some embodiments, such integrated circuits execute instructions that are stored on the circuit itself. In other embodiments, processing unit(s) 604 can execute instructions stored in local storage 606. Any type of processors in any combination can be included in processing unit(s) 604.

Local storage 606 can include volatile storage media (e.g., DRAM, SRAM, SDRAM, or the like) and/or non-volatile storage media (e.g., magnetic, or optical disk, flash memory, or the like). Storage media incorporated in local storage 606 can be fixed, removable, or upgradeable as desired. Local storage 606 can be physically or logically divided into various subunits such as a system memory, a read-only memory (ROM), and a permanent storage device. The system memory can be a read-and-write memory device or a volatile read-and-write memory, such as dynamic random-access memory. The system memory can store some or all of the instructions and data that processing unit(s) 604 need at runtime. The ROM can store static data and instructions that are needed by processing unit(s) 604. The permanent storage device can be a non-volatile read-and-write memory device that can store instructions and data even when module 602 is powered down. The term “storage medium” as used herein includes any medium in which data can be stored indefinitely (subject to overwriting, electrical disturbance, power loss, or the like) and does not include carrier waves and transitory electronic signals propagating wirelessly or over wired connections.

In some embodiments, local storage 606 can store one or more software programs to be executed by processing unit(s) 604, such as an operating system and/or programs implementing various server functions such as functions of the system 100 or any other system described herein, or any other server(s) associated with system 100 or any other system described herein.

“Software” refers generally to sequences of instructions that, when executed by processing unit(s) 604, cause server system 600 (or portions thereof) to perform various operations, thus defining one or more specific machine embodiments that execute and perform the operations of the software programs. The instructions can be stored as firmware residing in read-only memory and/or program code stored in non-volatile storage media that can be read into volatile working memory for execution by processing unit(s) 604. Software can be implemented as a single program or a collection of separate programs or program modules that interact as desired. From local storage 606 (or non-local storage described below), processing unit(s) 604 can retrieve program instructions to execute and data to process in order to execute various operations described above.

In some server systems 600, multiple modules 602 can be interconnected via a bus or other interconnect 608, forming a local area network that supports communication between modules 602 and other components of server system 600. Interconnect 608 can be implemented using various technologies, including server racks, hubs, routers, etc.

A wide area network (WAN) interface 610 can provide data communication capability between the local area network (e.g., through the interconnect 608) and the network 626, such as the Internet. Other technologies can be used to communicatively couple the server system 600 with the network 626, including wired (e.g., Ethernet, IEEE 602.3 standards) and/or wireless technologies (e.g., Wi-Fi, IEEE 602.11 standards).

In some embodiments, local storage 606 is intended to provide working memory for processing unit(s) 604, providing fast access to programs and/or data to be processed while reducing traffic on interconnect 608. Storage for larger quantities of data can be provided on the local area network by one or more mass storage 612 that can be connected to interconnect 608. Mass storage 612 can be based on magnetic, optical, semiconductor, or other data storage media. Direct attached storage, storage area networks, network-attached storage, and the like can be used. Any data stores or other collections of data described herein as being produced, consumed, or maintained by a service or server can be stored in mass storage 612. In some embodiments, additional data storage resources may be accessible via WAN interface 610 (potentially with increased latency).

Server system 600 can operate in response to requests received via WAN interface 610. For example, one of modules 602 can implement a supervisory function and assign discrete tasks to other modules 602 in response to received requests. Work allocation techniques can be used. As requests are processed, results can be returned to the requester via WAN interface 610. Such operation can generally be automated. Further, in some embodiments, WAN interface 610 can connect multiple server systems 600 to each other, providing scalable systems capable of managing high volumes of activity. Other techniques for managing server systems and server farms (collections of server systems that cooperate) can be used, including dynamic resource allocation and reallocation.

Server system 600 can interact with various user-owned or user-operated devices via a wide-area network such as the Internet. An example of a user-operated device is shown in FIG. 6 as computing system 614. Computing system 614 can be implemented, for example, as a consumer device such as a smartphone, other mobile phone, tablet computer, wearable computing device (e.g., smart watch, eyeglasses), desktop computer, laptop computer, and so on.

For example, computing system 614 can communicate via WAN interface 610. Computing system 614 can include computer components such as processing unit(s) 616, storage device 618, network interface 620, user input device 622, and user output device 624. Computing system 614 can be a computing device implemented in a variety of form factors, such as a desktop computer, laptop computer, tablet computer, smartphone, other mobile computing device, wearable computing device, or the like.

Processing unit 616 and storage device 618 can be similar to processing unit(s) 604 and local storage 606 described above. Suitable devices can be selected based on the demands to be placed on computing system 614. For example, computing system 614 can be implemented as a “thin” client with limited processing capability or as a high-powered computing device. Computing system 614 can be provisioned with program code executable by processing unit(s) 616 to enable various interactions with server system 600.

Network interface 620 can provide a connection to the network 626, such as a wide area network (e.g., the Internet) to which WAN interface 610 of server system 600 is also connected. In various embodiments, network interface 620 can include a wired interface (e.g., Ethernet) and/or a wireless interface implementing various RF data communication standards such as Wi-Fi, Bluetooth, or cellular data network standards (e.g., 3G, 4G, LTE, etc.).

User input device 622 can include any device (or devices) via which a user can provide signals to computing system 614; computing system 614 can interpret the signals as indicative of particular user requests or information. In various embodiments, user input device 622 can include any or all of a keyboard, touch pad, touch screen, mouse, or other pointing device, scroll wheel, click wheel, dial, button, switch, keypad, microphone, and so on.

User output device 624 can include any device via which computing system 614 can provide information to a user. For example, user output device 624 can include display-to-display images generated by or delivered to computing system 614. The display can incorporate various image generation technologies, e.g., a liquid crystal display (LCD), light-emitting diode (LED) display including organic light-emitting diodes (OLED), projection system, cathode ray tube (CRT), or the like, together with supporting electronics (e.g., digital-to-analog or analog-to-digital converters, signal processors, or the like). Some embodiments can include a device such as a touchscreen that function as both input and output device. In some embodiments, other user output devices 624 can be provided in addition to or instead of a display. Examples include indicator lights, speakers, tactile “display” devices, printers, and so on.

Some embodiments include electronic components, such as microprocessors, storage, and memory that store computer program instructions in a computer readable storage medium. Many of the features described in this specification can be implemented as processes that are specified as a set of program instructions encoded on a computer readable storage medium. When one or more processing units execute these program instructions, they cause the processing unit(s) to perform various operations indicated in the program instructions. Examples of program instructions or computer code include machine code, such as is produced by a compiler, and files including higher-level code that are executed by a computer, an electronic component, or a microprocessor using an interpreter. Through suitable programming, processing unit(s) 604 and 616 can provide various functionality for server system 600 and computing system 614, including any of the functionality described herein as being performed by a server or client, or other functionality.

It will be appreciated that server system 600 and client computing system 614 are illustrative and that variations and modifications are possible. Computer systems used in connection with embodiments of the present disclosure can have other capabilities not specifically described here. Further, while server system 600 and client computing system 614 are described with reference to particular blocks, it is to be understood that these blocks are defined for convenience of description and are not intended to imply a particular physical arrangement of component parts. For instance, different blocks can be, but need not be, located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present disclosure can be realized in a variety of apparatus including electronic devices implemented using any combination of circuitry and software.

While the disclosure has been described with respect to specific embodiments, one skilled in the art will recognize that numerous modifications are possible. Embodiments of the disclosure can be realized using a variety of computer systems and communication technologies, including but not limited to specific examples described herein. Embodiments of the present disclosure can be realized using any combination of dedicated components and/or programmable processors and/or other programmable devices. The various processes described herein can be implemented on the same processor or different processors in any combination. Where components are described as being configured to perform certain operations, such configuration can be accomplished, e.g., by designing electronic circuits to perform the operation, by programming programmable electronic circuits (such as microprocessors) to perform the operation, or any combination thereof. Further, while the embodiments described above may make reference to specific hardware and software components, those skilled in the art will appreciate that different combinations of hardware and/or software components may also be used and that particular operations described as being implemented in hardware might also be implemented in software or vice versa.

Computer programs incorporating various features of the present disclosure may be encoded and stored on various computer readable storage media; suitable media include magnetic disk or tape, optical storage media such as compact disk (CD) or digital versatile disk (DVD), flash memory, and other non-transitory media. Computer readable media encoded with the program code may be packaged with a compatible electronic device, or the program code may be provided separately from electronic devices (e.g., via Internet download or as a separately packaged computer-readable storage medium).

Thus, although the disclosure has been described with respect to specific embodiments, it will be appreciated that the disclosure is intended to cover all modifications and equivalents within the scope of the following claims.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

1. A system, comprising:
one or more processors coupled to memory, the one or more processors configured to:
maintain, in a local database in the memory and accessible to a browser extension of a browser application, a plurality of reference embeddings, each reference embedding of the plurality of reference embeddings stored in association with a respective reference domain;
determine, using the browser extension, that the browser application has accessed a web page;
determine, based on a network connection attribute, a delay for capturing a screenshot of the web page;
following the delay, capture, using the browser extension, the screenshot of the web page accessed via the browser application;
generate an image embedding for the screenshot using an embeddings model of the browser extension;
generate a plurality of similarity scores between the image embedding and the plurality of reference embeddings;
determine that a first similarity score of the plurality of similarity scores between the image embedding and a first reference embedding of the plurality of reference embeddings satisfies a threshold;
determine, responsive to determining that the first similarity score satisfies the threshold, that a domain of the web page fails to match the respective reference domain associated with the first reference embedding; and
interrupt access to the web page responsive to determining that the first similarity score satisfies the threshold and responsive to determining that the domain of the web page fails to match the respective reference domain associated with the first reference embedding.

2. The system of claim 1, wherein the one or more processors are further configured to block network access to the web page responsive to the first similarity score satisfying the threshold and the web page failing to match the respective reference domain associated with the first reference embedding.

3-4. (canceled)

5. The system of claim 1, wherein the one or more processors are further configured to receive the plurality of reference embeddings from a computing system.

6. The system of claim 1, wherein the embeddings model comprises one or more pre-trained convolution layers and at least one fine-tuned fully connected layer.

7. The system of claim 1, wherein the one or more processors are further configured to generate a notification indicating that the web page corresponds to a phishing attempt.

8. The system of claim 1, wherein the one or more processors are further configured to determine that access to the web page is to be restricted further based on at least one element of the web page.

9. The system of claim 1, wherein each similarity score of the plurality of similarity scores comprises one of a cosine similarity, an L1 similarity, or an L2 similarity.

10-12. (canceled)

13. The system of claim 1, wherein the one or more processors are further configured to train the embeddings model using a training dataset comprising a plurality of images depicting a respective plurality of login pages.

14. The system of claim 13, wherein at least two of the plurality of images comprise different dimensions.

15. The system of claim 1, wherein the one or more processors are further configured to interrupt access to the web page by preventing one or more interactions with the web page.

16. The system of claim 1, wherein the one or more processors are further configured to:
identify a uniform resource locator (URL) or uniform resource identifier (URI) associated with the web page; and
determine the domain of the web page based on the URL or the URI.

17. A method, comprising:
maintaining, by one or more processors coupled to memory, in a local database in the memory and accessible to a browser extension of a browser application, a plurality of reference embeddings, each reference embedding of the plurality of reference embeddings stored in association with a respective reference domain;
determining, by the one or more processors, using the browser extension, that the browser application has accessed a web page;
determining, by the one or more processors, based on a network connection attribute, a delay for capturing a screenshot of the web page;
following the delay, capturing, by the one or more processors, using the browser extension, the screenshot of the web page accessed via the browser application;
generating, by the one or more processors, an image embedding for the screenshot using an embeddings model of the browser extension;
generating, by the one or more processors, a plurality of similarity scores between the image embedding and the plurality of reference embeddings;
determining, by the one or more processors, that a first similarity score of the plurality of similarity scores between the image embedding and a first reference embedding of the plurality of reference embeddings satisfies a threshold;
determining, by the one or more processors, responsive to determining that the first similarity score satisfies the threshold, that a domain of the web page fails to match the respective reference domain associated with the first reference embedding; and
interrupting, by the one or more processors, access to the web page responsive to determining that the first similarity score satisfies the threshold and responsive to determining that the domain of the web page fails to match the respective reference domain associated with the first reference embedding.

18. The method of claim 17, further comprising blocking, by the one or more processors, network access to the web page responsive to the first similarity score satisfying the threshold and the web page failing to match the respective reference domain associated with the first reference embedding.

19-20. (canceled)
